(19) United States
(12) Patent Application Publication
(10) Pub. No.: US 2012/0110508 A1
(43) Pub. Date: May 3, 2012

(54) ENTERPRISE RESOURCE PLANNING ORIENTED CONTEXT-AWARE USER INTERFACE

(75) Inventor: Geoffrey Norman Bullen, Copenhagen (DK)

(73) Assignee: MICROSOFT CORPORATION, Redmond, WA (US)

(21) Appl. No.: 12/916,049

(22) Filed: Oct. 29, 2010

(51) Int. Cl. G06F 3/048

(52) U.S. Cl. 715/825; 715/841

(57) ABSTRACT

An Enterprise Resource Planning (ERP) context-aware user interface may be provided. A task list comprising a plurality of objectives may be displayed. Upon receiving a selection of at least one of the plurality of objectives, a context state may be updated according to the selected at least one objective. A suggestion list comprising a plurality of tags associated with the selected at least one objective may then be displayed.

### BACKGROUND

An Enterprise Resource Planning oriented context-aware user interface is a process for providing visualization involving data manipulations within an enterprise resource planning (ERP) environment. In some situations, a user may be presented with a great deal of information and/or actions that may be valuable in making business decisions, but have no guidance in which data or actions are the best to choose. For example, a user trying to requisition a laptop may be presented with a bewildering array of forms, part numbers, and approval processes with no idea what order to follow or which model laptop best suits their needs. For another example, the user may not even know that some information is available to assist in decision making unless they already know where to look for it.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

An Enterprise Resource Planning oriented context-aware user interface may be provided. Upon receiving a selection of at least one of the plurality of objectives, a context state may be updated according to the selected at least one objective. A suggestion list comprising a plurality of tags associated with the selected at least one objective may then be displayed.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a block diagram of a context-aware user interface;

FIGS. 3A-3C are block diagrams of a search function associated with the context-aware user interface;

FIG. 4 is a block diagram of a contact function associated with the context-aware user interface;

FIG. 5 is a flow chart of a method for providing a context-aware user interface; and

FIG. 6 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A context-aware user interface may be provided. Consistent with embodiments of the present invention, a user's interactions and operations within a software environment may be tracked, recorded, and/or analyzed. For example, an employee associated with a business organization may use the software environment to achieve a certain objective that requires access to business data, such as a human resources manager producing a report summarizing current employee benefit choices. The context-aware user interface may track each action requested by the employee, such as retrieving a list of all employees, retrieving a list of all available benefit choices, and mapping each employee to one or more choices. With each action from the user, the interface may automatically arrange, add, and/or remove displayed windows to aid the user's work flow.

Consistent with embodiments of the invention, workflow assistance functions may be provided as part of an Enterprise Resource Planning (ERP) application. Such functions may comprise search result sorting and/or user contact management. For example, search results may be visually represented as a prioritized grid and/or book. The contact management function, for example, may sort other users into groups by type of connection and/or according to how likely the user may be to assist in a given work task.

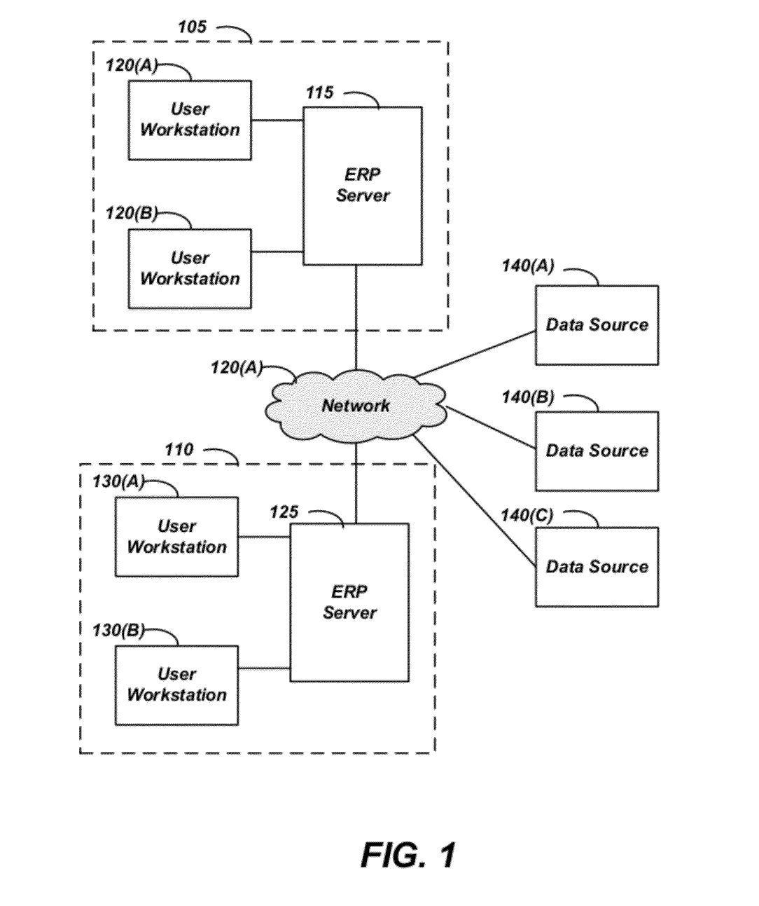

FIG. 1 is a block diagram of an operating environment 100 comprising a first organization 105 and a second organization 110. First organization 105 may comprise a first Enterprise Resource Planning (ERP) server 115 and a first plurality of user workstations 120(A)-(B). Second organization 110 may similarly comprise a second Enterprise Resource Planning (ERP) server 125 and a second plurality of user workstations 130(A)-(B). User workstations 120(A)-(B) and 130(A)-(B) may be coupled to respective ERP servers 115 and 125, such as by a local area network (LAN). First organization 105 and second organization 110 may be communicatively coupled via a network 135. Network 135 may comprise a private network and/or a public network such as the Internet. Operating environment 100 may further comprise a plurality of data sources 140(A)-(C). Data sources 140(A)-(C) may comprise organization-specific data sources, such as an offsite data storage and/or backup facility, public data sources, such as a stock market quote service and/or a weather data service, and/or subscription, partner, customer, and/or client data sources. For example, data source 140(A) may be associated with an insurance company providing health care benefits to first organization 105 and/or second organization 110.

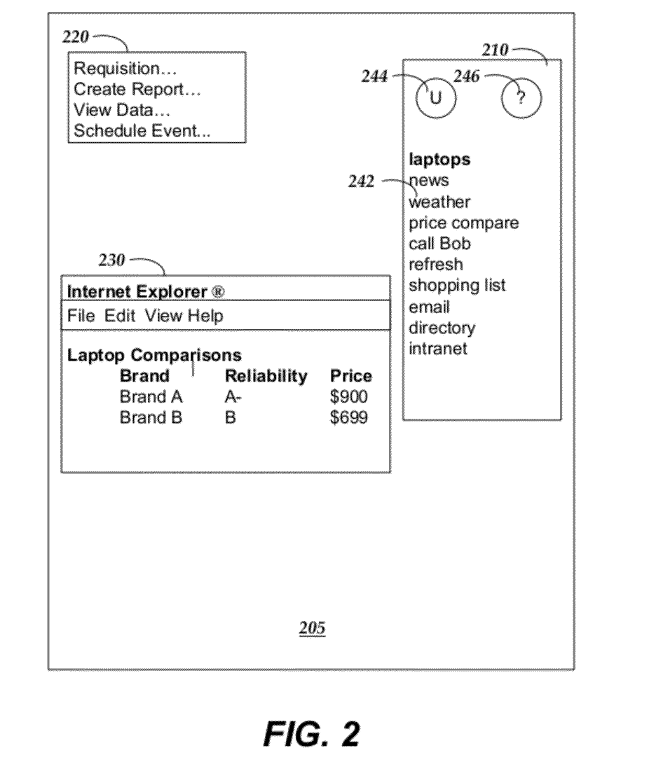

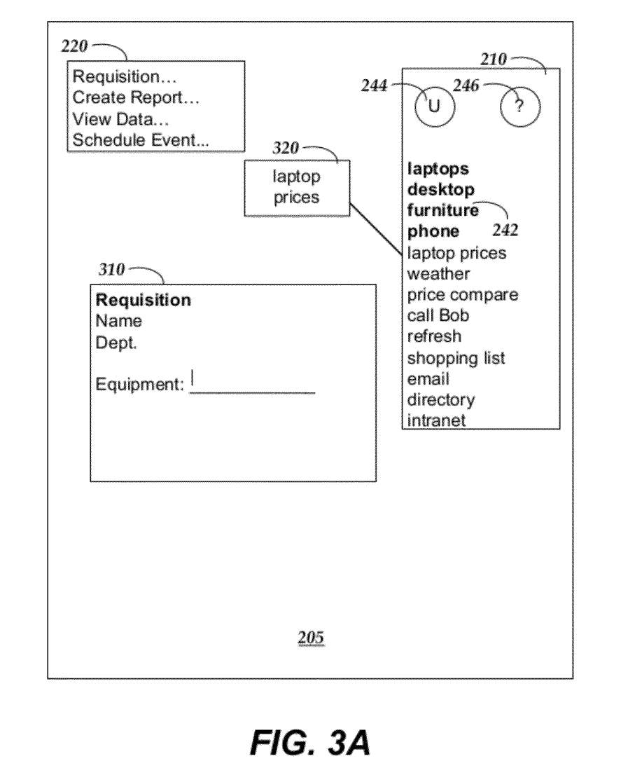

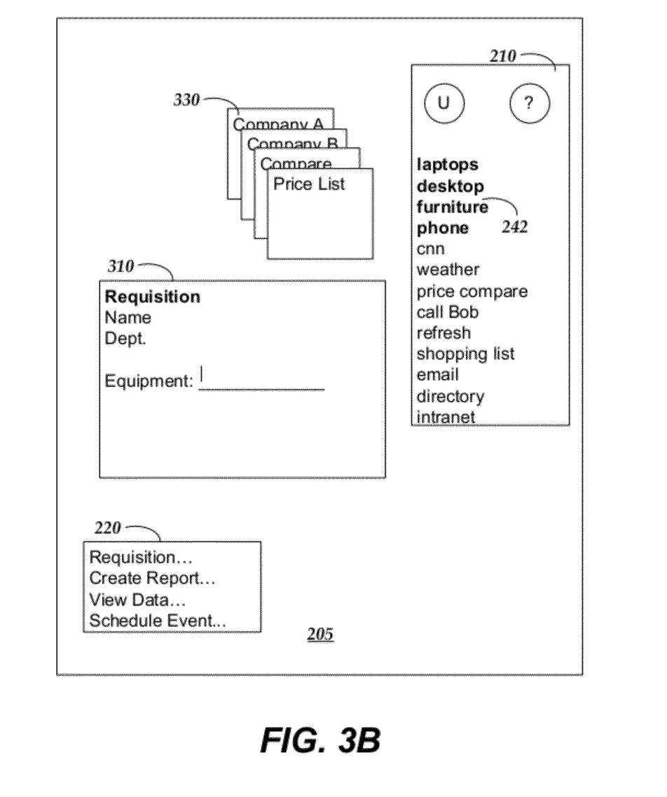

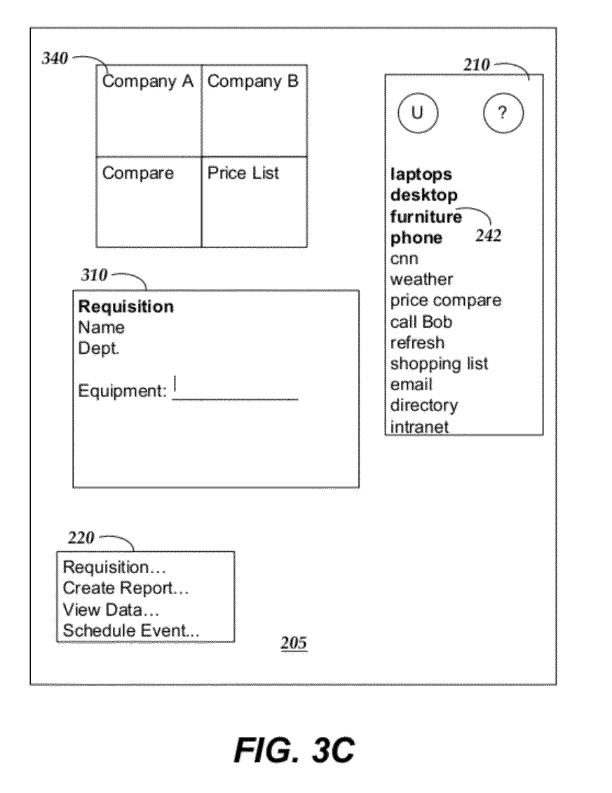

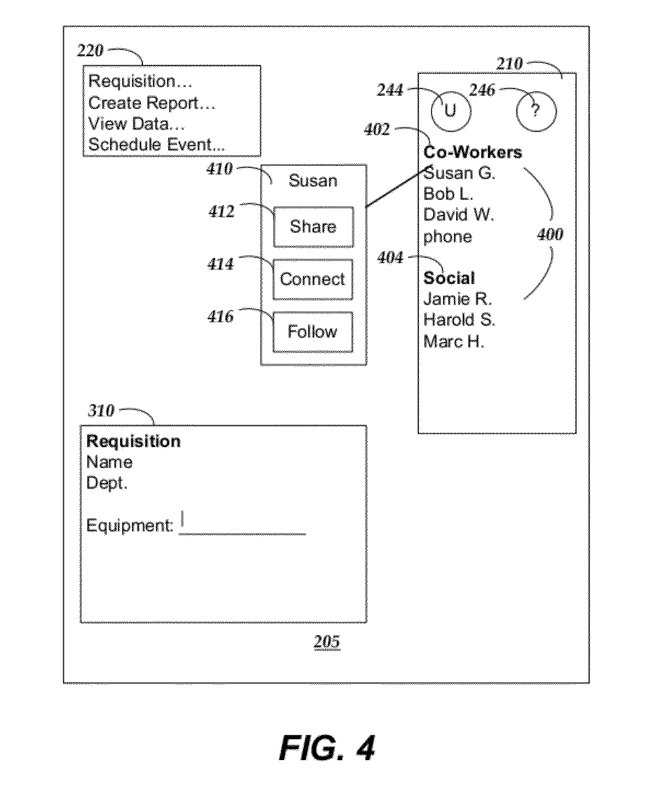

FIG. 2 is a block diagram of an interface 200 for providing a suggested next action in a context-aware user interface comprising a workspace 205, a suggestion list 210, an action list 220, and a current task window 230. Suggestion list 210 may comprise, for example, a plurality of context-related suggestions 242 and a plurality of option buttons such as a user-related suggestion button 244 and a workflow-related suggestion button 246. Selection of workflow-related suggestion button 246 may cause suggestion list 210 to be populated with task-assisting suggestions such as search terms, as described below in greater detail with respect to FIGS. 3A-3C. Selection of user-related suggestion button 244 may cause suggestion list 210 to be populated with users associated with similar contexts, as described below in greater detail with respect to FIG. 4. Current task window 230 may comprise, for example, an application window such as a web browser. The browser history, such as terms searched and sites visited, may be associated with the user's context and used to aid in later workflow tasks.

FIG. 3A is a block diagram of interface 200 for providing search results. For example, upon selection of a task in action list 220, such as creating a requisition order, a new task window 310 may be created and suggestion list 210 may be populated with next action and/or search term suggestions. A user may select one of the search terms 320 (e.g., “laptop prices”) and drag that term to workspace 205.

FIG. 3B is a block diagram of an embodiment of interface 200 updated after the selection of search term 320. Updated interface 200 may comprise a re-arrangement of windows, such as action list 220, and a creation of a book display 330 of search results associated with search term 320. Book display 330 may comprise a stack of overlapping search result windows that may be individually and/or group selected by the user for dragging around the desktop, re-ordering, and/or expanding into a larger window.

FIG. 3C is a block diagram of a second embodiment of interface 200 updated after the selection of search term 320. Updated interface 200 may comprise a grid display 340 of search results associated with search term 320. Grid display 340 may comprise, for example, sorted, thumbnail versions of browser windows associated with search term 320.

FIG. 4 is a block diagram of interface 200 updated after a selection of user option button 244. Suggestion list 210 may comprise a plurality of context-related contacts 400 that may be sorted and/or subdivided. For example, plurality of context-related contacts 400 may be divided contacts a co-worker list 402 and a social networking list 404. Selection of one of the contacts may cause a contact window 410 to be displayed comprising a share workspace button 412, a connect with contact button 414, and/or a follow workflow button 416. Selection of share workspace button 412 may allow the user to connect to the selected contact's workstation and share a desktop view and/or share a view of workspace 205; it may also allow the user to send an XML file comprising the user's current context to the selected contact allowing the contact to re-create workspace 205 on their own workstation. Selection of connect with contact button 414 may allow the user to communicate directly with the contact, such as via phone, instant messaging, and/or email. Selection of follow workflow button 416 may cause workspace 205 to display windows and/or suggestion list items to guide the user through a process followed by the selected contact to accomplish a task, such as that associated with new task window 310.

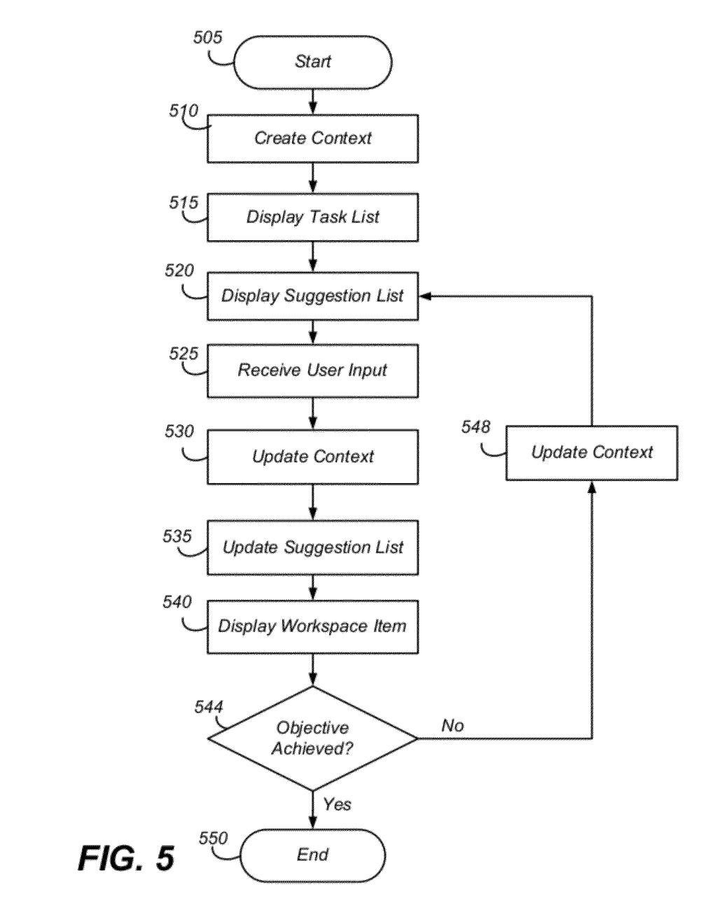

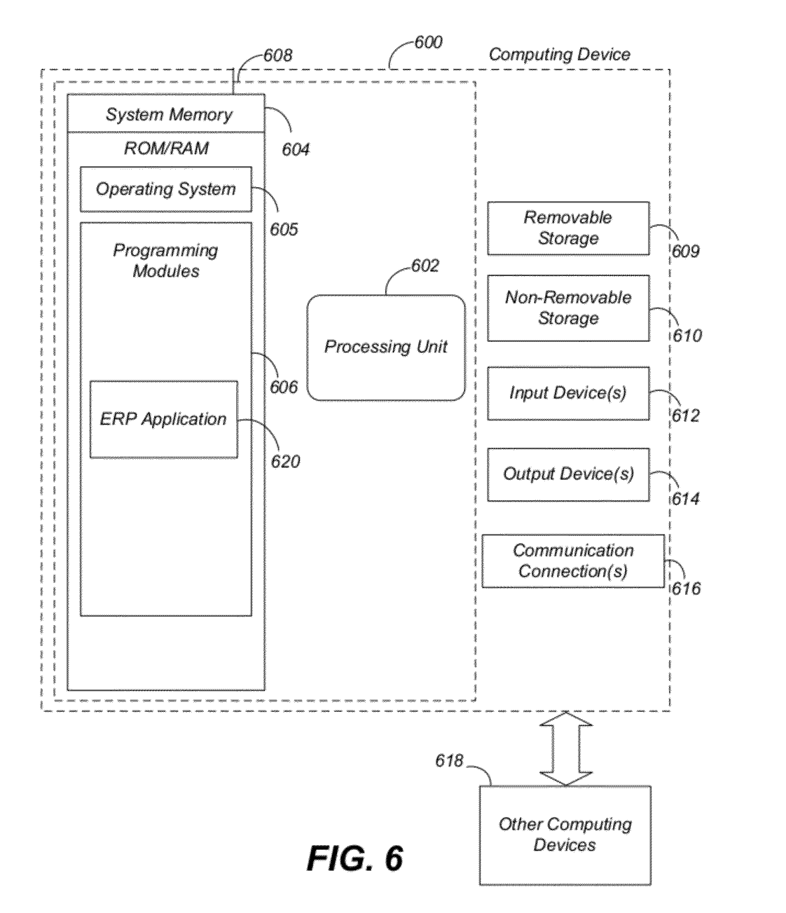

FIG. 5 is a flow chart setting forth the general stages involved in a method 500 consistent with an embodiment of the invention for providing can ERP context-aware environment. Method 500 may be implemented using a computing device 600 as described in more detail below with respect to FIG. 6. Ways to implement the stages of method 500 will be described in greater detail below. Method 500 may begin at starting block 505 and proceed to stage 510 where computing device 600 may create a context state associated with a user. For example, the user's context state may comprise user data such as a name, application preferences, recent activity, and/or location. The context state may also comprise user-independent data such as a time and/or date.

Method 500 may then advance to stage 515 where computing device 600 may display a task list comprising a plurality of objectives in a workspace. The objectives may be associated with the user's context state. For example, a user's context comprising recent web searches on laptop prices may result in enterprise resource planning (ERP) objectives associated with equipment purchases and/or requisitions in task list 220.

Method 500 may then advance to stage 520 where computing device 600 may display a suggestion list comprising a plurality of tags in the workspace. For example, suggestion list 210 may be displayed in workspace 205.

Method 500 may then advance to stage 525 where computing device 600 may receive a user input. For example, a user of user workstation 120(A) may select a task to create an equipment requisition from task list 220.

Method 500 may then advance to stage 530 where computing device 600 may update the context state according to the user input. For example, upon selecting the equipment requisition task, the user's context state may be updated with data from ERP server 115 associated with other users who have completed the same task.

Method 500 may then advance to stage 535 where computing device 600 may update the suggestion list with at least one new tag according to the updated context state. For example, suggestion list 210 may be updated with a search term of “laptop prices” based on the user's prior web browsing history as stored in the context state and/or with a suggested next action of reviewing instructions for completing the requisition form based on other users' viewing of that document when attempting to complete the same task.

Method 500 may then advance to stage 540 where computing device 600 may display a workspace item associated with the received user input. For example, upon selection of one of the plurality of objectives, a task window associated with the selected objective may be displayed in workspace 205. For another example, upon selection of a search term in suggestion list 210, a plurality of search results, such as book display 330 and/or grid display 340 may be displayed in workspace 205.

From stage 540, method 500 may advance to stage 544 where computing device 600 may determine whether the user's objective has been completed. For example, the user may have finalized a report and closed the file, indicating that the objective has been completed. Alternatively, the user may have selected another data item from suggestion list 210 to add to a report, indicating that the objective has not been completed. Consistent with embodiments of the invention, the user may also approve or disapprove of an automatically executed suggested action. For example, if the user performs an “undo” function, the action may be disapproved, indicating that the action did not further the desired and/or predicted objective.

If computing device 600 determines that the objective is not completed at stage 544, method 500 may advance to stage 548 where computing device 600 may update the context, as described above with respect to stage 530. Otherwise, once the objective is completed, method 500 may end at stage 550.

An embodiment consistent with the invention may comprise a system for providing a context-aware user interface. The system may comprise a memory storage and a processing unit coupled to the memory storage. The processing unit may be operative to display a task list comprising a plurality of objectives, receive a selection of at least one of the plurality of objectives, update a context state according to the selected at least one objective, and display a suggestion list comprising a plurality of tags associated with the selected at least one objective. The plurality of tags may comprise, for example, a suggested action, a suggested search term, a contact, a keyword, a related website, a related document, and a related data item. The processing unit may be further operative to display a task window associated with the selected at least one objective comprising, for example an ERP document that may be at least partially pre-populated according to the context state. The processing unit may be further operative to receive a selection of at least one of the plurality of tags, update the context state according to the selected at least one tag, and display a new workspace item associated with the selected at least one tag. For example, the selected tag may comprise a search term and the new workspace item may comprise search results. The processing unit may be further operative to receive an input comprising a drag and drop of at least one of the search results onto the task window and, in response, to populate at least one field of the ERP document according to the search result.

Another embodiment consistent with the invention may comprise a system for providing a context-aware user interface. The system may comprise a memory storage and a processing unit coupled to the memory storage. The processing unit may be operative to create a context state associated with a user, display a suggestion list comprising a plurality of tags associated with the context state, receive an action request from the user, update the context state according to the action request, and update the suggestion list with at least one new tag according to the updated context state. The suggestion list may comprise a plurality of tag option selection buttons, such as a user-related option and a workflow-related option, wherein the plurality of tags are each associated with a currently selected one of the plurality of tag option selection buttons. Upon selection of the user-related option button, the processing unit may be operative to display a plurality of contact tags in the suggestion list, such as those of another user associated with the same organization and/or social network as the selecting user.

Yet another embodiment consistent with the invention may comprise a system for providing a context-aware environment. The system may comprise a memory storage and a processing unit coupled to the memory storage. The processing unit may be operative to create a context state associated with a user, display a task list comprising a plurality of objectives in a workspace, wherein at least one of the plurality of objectives is associated with the context state, display a suggestion list comprising a plurality of tags in the workspace, wherein at least one of the plurality of tags is associated with the context state, receive a user input, update the context state according to the user input, and update the suggestion list with at least one new tag according to the updated context state. If the user input comprises a selection of at least one of the plurality of objectives, the processing unit may be operative to display a task window associated with the at least one of the plurality of objectives in the workspace. If the user input comprises a selection of at least one of the plurality of tags, the processing unit may be operative to display a new workspace item associated with the selected at least one tag.

FIG. 6 is a block diagram of a system including computing device 600. Consistent with an embodiment of the invention, the aforementioned memory storage and processing unit may be implemented in a computing device, such as computing device 600 of FIG. 6. Any suitable combination of hardware, software, or firmware may be used to implement the memory storage and processing unit. For example, the memory storage and processing unit may be implemented with computing device 600 or any of other computing devices 618, in combination with computing device 600. The aforementioned system, device, and processors are examples and other systems, devices, and processors may comprise the aforementioned memory storage and processing unit, consistent with embodiments of the invention. Furthermore, computing device 600 may comprise an operating environment for system 100 as described above. System 100 may operate in other environments and is not limited to computing device 600.

With reference to FIG. 6, a system consistent with an embodiment of the invention may include a computing device, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination. System memory 604 may include operating system 605, one or more programming modules 606, and may include a certificate management module 607. Operating system 605, for example, may be suitable for controlling computing device 600′s operation. Furthermore, embodiments of the invention may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 (e.g. ERP application 620) may perform processes including, for example, one or more of method 500′s stages as described above. The aforementioned process is an example, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing a context-aware user interface, the method comprising:
displaying a task list comprising a plurality of objectives;
receiving a selection of at least one of the plurality of objectives;
updating a context state according to the selected at least one objective; and
displaying a suggestion list comprising a plurality of tags associated with the selected at least one objective.

2. The method of claim 1, wherein the plurality of tags comprise at least one of the following: a suggested action, a suggested search term, a contact, a keyword, a related website, a related document, and a related data item.

3. The method of claim 1, wherein the plurality of objectives is displayed according to the context state prior to receiving the selection.

4. The method of claim 1, further comprising displaying a task window associated with the selected at least one objective.

5. The method of claim 4, wherein the task window comprises an enterprise resource planning (ERP) document.

6. The method of claim 5, further comprising populating at least one field of the ERP document according to the context state.

7. The method of claim 5, further comprising:
receiving a selection of at least one of the plurality of tags;
updating the context state according to the selected at least one tag; and
displaying a new workspace item associated with the selected at least one tag.

8. The method of claim 7, wherein the selected at least one tag comprises a search term and wherein the new workspace item comprises a plurality of search results.

9. The method of claim 8 wherein the plurality of search results comprise a grid display.

10. The method of claim 8 wherein the plurality of search results comprise a book display.

11. The method of claim 7, further comprising:
receiving an input comprising a drag and drop of at least one of the search results onto the task window; and
populating at least one field of the ERP document according to the search result.

12. A computer-readable medium which stores a set of instructions which when executed performs a method for providing a context-aware user interface, the method executed by the set of instructions comprising:
creating a context state associated with a user;
displaying a suggestion list comprising a plurality of tags associated with the context state;
receiving an action request from the user;
updating the context state according to the action request; and
updating the suggestion list with at least one new tag according to the updated context state.

13. The computer-readable medium of claim 12, wherein the suggestion list comprises a plurality of tag option selection buttons and wherein the plurality of tags are each associated with a currently selected one of the plurality of tag option selection buttons.

14. The computer-readable medium of claim 13, wherein the plurality of tag option buttons comprise at least one of the following: a user-related option and a workflow-related option.

15. The computer-readable medium of claim 14, further comprising:
receiving a selection of the user-related option button; and
displaying a plurality of contact tags in the suggestion list.

16. The computer-readable medium of claim 15, wherein at least one of the plurality of contact tags is associated with another user associated with an organization to which the user belongs.

17. The computer-readable medium of claim 15, wherein at least one of the plurality of contact tags is associated with another user associated with a social network to which the user belongs.

18. The computer-readable medium of claim 15, further comprising:
receiving a selection of at least one of the plurality of contact tags; and
displaying a contact item comprising a plurality of contact option buttons.

19. The computer-readable medium of claim 18, wherein the plurality of contact option buttons comprise at least one of the following: a telephone option, an instant messaging option, an email option, a share workspace option, and a workflow display option.

20. A system for providing a context-aware user interface, the system comprising:
a memory storage; and
a processing unit coupled to the memory storage, wherein the processing unit is operative to:
create a context state associated with a user,
display a task list comprising a plurality of objectives in a workspace, wherein at least one of the plurality of objectives is associated with the context state,
display a suggestion list comprising a plurality of tags in the workspace, wherein at least one of the plurality of tags is associated with the context state,
receive a user input,
update the context state according to the user input,
update the suggestion list with at least one new tag according to the updated context state,
determine whether the user input comprises a selection of at least one of the plurality of objectives,
in response to determining that the user input comprises the selection of the at least one of the plurality of objectives, display a task window associated with the at least one of the plurality of objectives in the workspace,
in response to determining that the user input does not comprise the selection of the at least one of the plurality of objectives, determine whether the user input comprises a selection of at least one of the plurality of tags, and
in response to determining that the user input comprises the selection of the at least one of the plurality of tags, display a new workspace item associated with the selected at least one tag.
